(19) United States
(12) Patent Application Publication
(10) Pub. No.: US 2005/0103869 A1
(43) Pub. Date: May 19, 2005

(54) Dual wavelength near infrared detector for enhanced indicia detection

(75) Inventors: Paul J. Guiguizian, Pittsford, NY (US); Kevin W. Williams, Rochester, NY (US); Arthur A. Whitfield, Rochester, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/712,222

(22) Filed: Nov. 13, 2003

(51) Int. Cl. G06K 7/10

(52) U.S. Cl. 235/468

(57) ABSTRACT

The present invention relates to a method of detecting indicia on media and an imaging apparatus adapted to detect indicia on media. The indicia on the media contains near infrared absorbing dye and the method and apparatus comprises using dual detectors. One of the detectors is adapted to be used at the peak absorption wavelength of the dye in the indicia and the other detector is adapted to be used off of the peak to detect and remove variations caused by the media.

### CROSS REFERENCE TO RELATED APPLICATIONS

The present application is related to the following pending patent application: U.S. patent application Ser. No. 10/144,487 filed May 13, 2002, entitled A MEDIA DETECTING METHOD AND SYSTEM FOR AN IMAGING APPARATUS.

### FIELD OF THE INVENTION

The present invention relates to the concept of detecting indicia printed on media, such as photographic or ink jet paper, that is to be utilized in an imaging apparatus such as a printer or a scanner. More specifically, the present invention relates to increasing the detectability of near infrared (NIR) indicia through the use of a dual wavelength NIR detector.

### BACKGROUND OF THE INVENTION

Many existing products, such as photographic paper, have markings such as logos that use carbon black ink. The addition of a narrow band NIR (near infrared) absorbing dye to existing printed indicia, or indicia that uses narrow band NIR absorbing ink, can be used as a hidden tag for various purposes, such as identifying media type. The detection of indicia requires that the indicia have high enough contrast to be detectable. Preexisting markings and media surface variations can make detection more difficult and less reliable.

### SUMMARY OF THE INVENTION

The present invention relates to a detection scheme that increases the detection of NIR based indicia by using two detectors at different wavelengths. The detection of added NIR ink can be enhanced through the use of dual detectors. A primary detector can be used at the peak NIR absorption wavelength of the added dye, and the secondary detector is used off of that peak to detect and remove variations caused by media surface irregularities and other marks on the media that have the same absorption at both wavelengths. The signal from the second detector is subtracted from the first detector leaving only the signal caused by the NIR dye. The detectors can be simple silicon based 880 nm and 940 nm detectors. Illumination can be by way of light emitting diodes or wideband illumination with IR filters.

Additives, such as a narrow band 880 nm NIR absorbing dye, is added to the indicia or used for the indicia, so that only a narrow part of the NIR band is absorbed. Two detectors are used to detect the indicia, one detector at the 880 nm NIR absorption wavelength of the ink, and a second detector, 940 nm for example, outside of the ink absorption band. The second detector is used to subtract variation in lighting and media leaving only a signal due to the added 880 nm NIR dye.

Every detection scheme must contend with a signal and noise. Increasing the signal and/or decreasing the noise improve the detection of the signal. There are many sources of noise. In this invention, the noise is considered to be illumination variations caused by the surface of the media and from other indicia on the media that has absorption at the same wavelength of the added NIR dye. The assumption is that the reflectivity of the media and the absorption of existing marks are the same for the two chosen wavelengths. If existing marks have absorption at the NIR wavelengths to be used by the added dye, it is very likely that the existing marks have absorption outside of the added NIR dye. The existing marks are most often visible. This invention uses two detectors. The first detector measures both the signal and noise, and the second detector measures only the noise. The difference between those two detectors is used to remove the noise from the signal leaving only the signal. Without added dye, both detectors would always have the same signal.

In the method of the present invention, both detectors should be focused on the same location on the media. There are several methods for accomplishing this task. If detection is required on a stationary media, then the signal can be split and passed through two separate narrow band IR filters. Each filter covers a wideband detector, such as a PIN photodiode. If the media is moving, then two separate detectors or sensors can be placed side-by-side, along the axis of motion, and the first detector output can be delayed with respect to the second detector output so that the signals can be properly aligned. The delay can be performed in analog or after digitization by a computer. A third method is to time multiplex the detector. Two light sources, such as 880 nm and 940 nm LEDs, can be strobed on and off in sequence to obtain signals at each wavelength. The signals can then be conditioned and subtracted in analog or digital space. A forth method might be to use a diffraction grating to separate the signal into two wavelengths for detection rather than use two optical filters.

The present invention therefore relates to a method of detecting indicia on media, wherein the indicia contains a band of near infrared absorbing dye. The method comprises a first step of illuminating the indicia on the media at a first wavelength which is approximately within an absorption band wavelength of the dye on the indicia; a second step of illuminating the indicia on the media at a second wavelength which is outside of the absorption band wavelength; detecting a first light signal from the first illuminating step; detecting a second light signal from the second illuminating step; and calculating a difference between the first light signal and the second light signal, such that the difference represents the dye on the indicia.

The present invention further relates to an imaging apparatus which comprises a media path for the passage of media there-through; at least one light source adapted to direct at least one beam of light onto indicia on media in the media path, wherein the at least one light source is adapted to direct a first beam of light at a first wavelength, the first wavelength is within an absorption band to detect added dye in said indicia, and the at least one light source is further adapted to direct a second beam of light at a second wavelength which is outside of the absorption band; a detecting system adapted to detect a first reflected light from the first beam and provide a first signal indicative thereof, and a second reflected light from the second beam and provide a second signal indicative thereof; and a controller adapted to receive the first and second signals and calculate a difference between the first and second signals, such that the difference represents dye on the indicia.

### BRIEF DESCRIPTION OF THE DRAWINGS

FIG. 1 schematically illustrates a first embodiment of an imaging apparatus in accordance with the present invention;

FIG. 2 schematically illustrates a second embodiment of an imaging apparatus in accordance with the present invention; and

FIG. 3 schematically illustrates a third embodiment of an imaging apparatus in accordance with the present invention

### DETAILED DESCRIPTION OF THE INVENTION

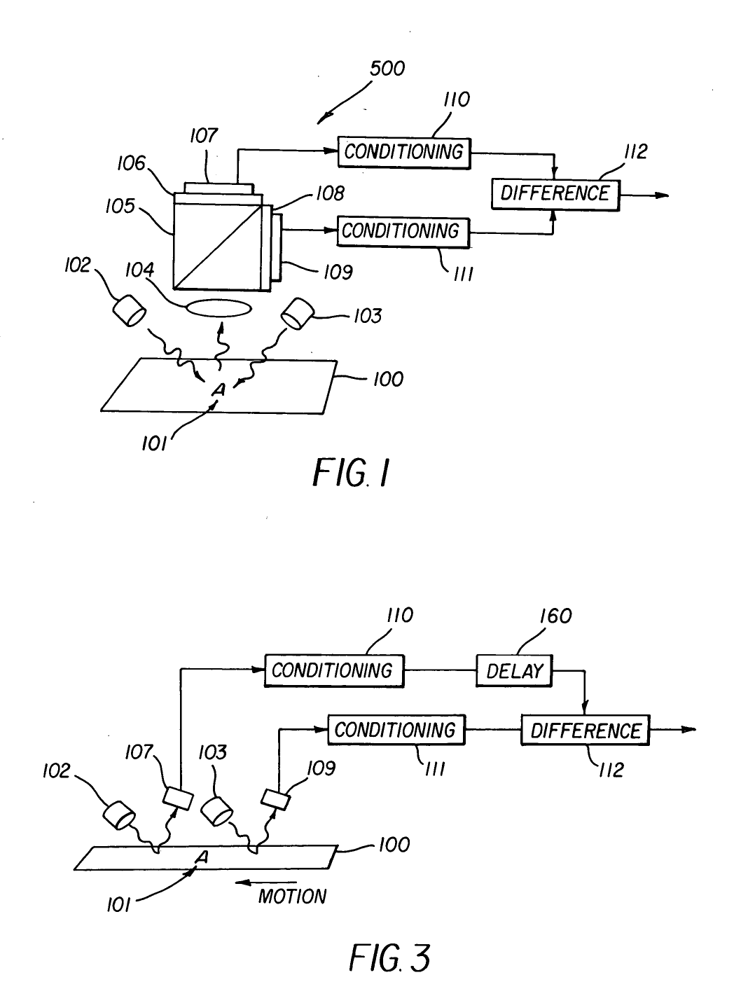

Referring now to the drawings, wherein like reference numerals designate identical or corresponding parts throughout the several views, FIG. 1 illustrates an imaging apparatus 500 in accordance with a first embodiment of the present invention. In order to enable the detection scheme of the present invention, the detectors at each wavelength should image the same location on the media. In imaging apparatus 500 of FIG. 1, illumination from two light sources 102 and 103 illuminate indicia 101 on media 100. The light sources 102 and 103 are at two different wavelengths or bands of wavelengths, for example, light source 102 has a peak at 880 nm or is within the absorption band wavelength of dye or ink on the indicia on media 100. Light source 103 has a peak at 940 nm or is outside of the absorption band wavelength of the dye or ink on the indicia on media 100. It is also possible to use one light source that covers both wavelengths. The illumination is reflected and absorbed by media 100 and passed through a focusing lens 104. Light passes through lens 104 and is split by a beam splitter 105 into two paths. Part of the light or a first path of light passes straight through a filter 106 and into detector 107. Part of the light or a second path of light reflects off the beam splitter and passes through a filter 108 and into a detector 109. Filter 106 is adapted to pass only approximately 880 nm illumination, and filter 108 is adapted to pass only approximately 940 nm illumination. Another way to achieve this is to use a filter that passes the approximately 880 nm light or illumination into detector 107, and reflects the approximately 940 nm light or illumination into detector 109 rather than a beam splitter and filters. Focusing lens 104 focus the indicia on the surface of media 100 onto detectors 107 and 109. Each detector 107, 109 respectively has conditioning electronics 110, 111 to provide amplification, filtering, offset and gain adjustments to both improve the signals from detectors 107 and 109 and prepare them for subtraction by a circuit or controller 112. The operation of circuit or controller 112 could be done by a microcontroller that digitizes both signals from detectors 107 and 109, performs any required adjustments to each signal, does the subtraction and could handle additional processing such as level detection, lamp monitoring and lamp level adjustments.

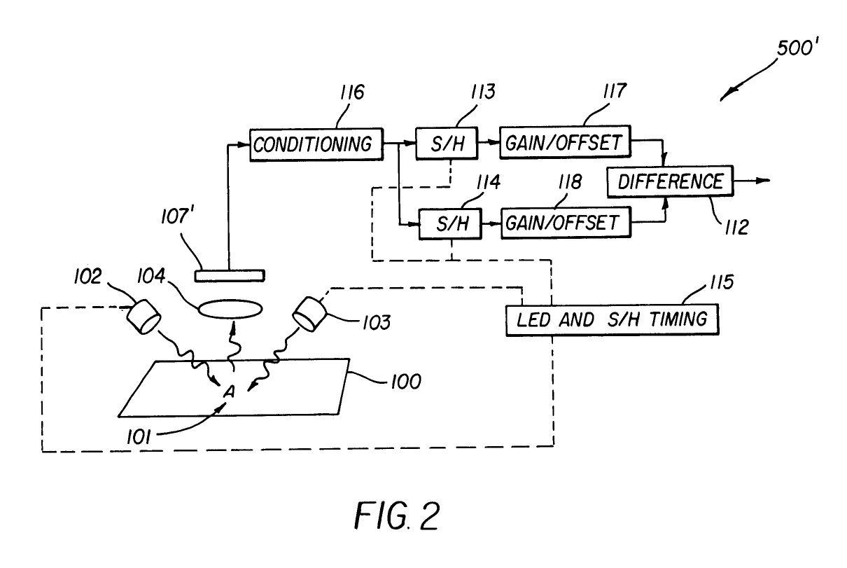

FIG. 2 illustrates a further embodiment of an imaging apparatus in accordance with the present invention in which one detector works at both wavelengths to multiplex the illumination. In imaging apparatus 500′ of FIG. 2 one light source is turned on at a time and the electronics have an additional requirement of having to store the values of the detectors in a sample and hold circuit and rapidly switch the light source on and off. It is possible to use the method of FIG. 2 when the media is moving if the multiplexing of the light sources is fast enough. Light sources 102, 103 can be LEDs that can be turned on and off very rapidly. Any overlap of the illumination spectrums from the LEDs would decrease the indicia contrast enhancement provided by this scheme, so filters over the light sources may be required. Ideally, filters and a beam splitter are not needed.

In the apparatus of FIG. 2, a timing controller 115 turns on a light source or emitter 102 or 103. NIR 880 nm light from source 102 illuminates indicia 101 on media 100. Lens 104 focuses the light reflected off media 100 into detector 107′ which could be a photo-detector. Conditioning electronics 116 converts the signal or photodiode signal from detector 107′ into a voltage and provides filtering if necessary. A sample and hold circuit arrangement 113, 114 tracks the signal until timing controller 115 places it into hold mode. When timing controller 115 places sample and hold circuit 113 into hold mode, emitter 102 is turned off and emitter 103 is turned on. Now NIR 940 nm light from source 103 illuminates indicia 101 on media 100. Lens 104 focuses the light reflected off media 100 into photo detector 107. Just like the case with the 880 nm light, conditioning electronics 116 converts the photodiode signal into a voltage and provides filtering. The timing controller 115 now operationally associated with sample and hold circuit 114 tracks the detector signal. A short time later, depending on the speed of the electronics, timing controller 115 sets sample and hold circuit 114 into a hold mode holding the 940 nm signal, 940 nm emitter 102 is turned off and the 880 nm emitter is turned on. This pattern is repeated alternating the turning on and off of emitters 102 and 103 and the holding of detector signals. The output of the hold circuits 113, 114 are fed into a gain and offset electronics arrangement 117 and 118 to perform level and amplitude adjustments prior to subtraction by circuit or controller 112. Circuit 112 obtains the absolute difference between the two signals. This signal will be the difference between the 940 nm and 880 nm reflectivity of the media. The output of circuit 112 is then passed to a level detector, or some other means of detecting peaks in the signal.

This method and apparatus of FIG. 2 is best suited for stationary media, and some limited range of motion dependent on the rate of oscillation of the emitters. Much of the analog circuit can be replaced with a micro-controller. A micro-controller can be used to provide the switching of the emitters, light level control, digitization, gain and offset, sample and hold, and level detection.

A further embodiment of an imaging apparatus in accordance with the present invention is illustrated in FIG. 3. The embodiment of FIG. 3 utilizes two separate emitter/detector pairs with a detector being used for each wavelength. The media should be moving at a constant velocity and the detector placed along the line of motion. A first detector signal is digitized and delayed relative to a second digitized detector signal. The delay is used so that the two detectors appear to be viewing the same location on the media. In the method of FIG. 3 the velocity of the media and the digitization rate should be known so that the proper amount of delay can be calculated. An example of this arrangement would be two off the shelf reflective sensors; one at 880 nm and the other at 940 nm. The delay could be performed in analog or digital space. All signal conditioning, with the exception of the added delay, would be the same as in the previous embodiments. If the velocity of the media is not known, correlation of the two signals can be used to determine the delay. The two detectors would not require filters if there is no environmental lighting at those wavelengths and if each light source only illuminates its corresponding detector.

In FIG. 3, indicia 101 on moving media 100 is illuminated by an 880 nm light source or emitter 102 and a 940 nm light source or emitter 103 which can be LEDs. Light from emitter 102 is focused onto detector or photodiode 107. Light from emitter 103 is focused onto a further detector or photodiode 109. Photodiodes 107 and 109 can have integrated lenses. The signal from photodiode 107 is conditioned by electronics 110 and the signal from photodiode 109 is conditioned by electronics 111. The conditioning electronics 110 and 111 provide current to voltage conversion, filtering, amplification and DC offset adjustments. The signal from conditioning electronics 110 goes through an additional delay 160. The delay is dependent on the velocity of the media. The delay is necessary so that the two signals received by difference circuit 112, are from the same part of the media. As in the other embodiments, a micro-controller or micro-processor can replace parts of this circuit. A computer can digitize and store the signals, perform the delay, and even calculate the delay based on the cross correlation of the two signals.

In some instances, the logos on photographic paper can have absorption in the same NIR wavelengths than the dyes used. With the context of the present invention, improved detectability of the indicia can be achieved by increasing the amount of NIR dye or ink on the logo to a value where the contrast of the dye or ink exceeds the contrast of the logo or carbon black printing, and using the detecting schemes described in this application and illustrated in FIGS. 1-3.

Although the present application describes wavelengths for the light sources and detectors for the preferred embodiment as being 800 nm and 940 nm, the present invention is not limited to these values. It is recognized that the values for the wavelengths can be altered, changes or modified based on LED and detector device design and manufacture, or other means of IR illumination detection.

The invention has been described in detail with particular reference to certain preferred embodiments thereof, but it will be understood that variations and modifications can be effected within the spirit and scope of the invention.

1. A method of detecting indicia on media, wherein the indicia contains near infrared absorbing dye, the method comprising:
a first step of illuminating the indicia on the media at a first wavelength which is approximately within an absorption band wavelength of the dye on the indicia;
a second step of illuminating the indicia on the media at a second wavelength which is outside of said absorption band wavelength;
detecting a first light signal from said first illuminating step;
detecting a second light signal from said second illuminating step; and
calculating a difference between said first light signal and said second light signal, such that the difference represents the dye on the indicia.

2. A method according to claim 1, wherein said indicia is a backside logo on the media.

3. A method according to claim 1, wherein said media is a web or a cut sheet.

4. A method according to claim 1, wherein said media is photographic paper.

5. A method according to claim 1, wherein said first and second illuminating steps occur at the same location on the media.

6. A method according to claim 1, wherein said first and second illuminating steps comprises directing light from at least one light source toward the indicia on the media.

7. A method according to claim 6, wherein said at least one light source is a light emitting diode.

8. A method according to claim 1, wherein prior to said first step of illuminating the indicia, the method comprises adding infrared dye to the indicia to increase an amount of infrared dye in the indicia to a value where a contrast of the infrared dye exceeds a contrast of the indicia.

9. An imaging apparatus comprising:
a media path for the passage of media therethrough;
at least one light source adapted to direct at least one beam of light onto indicia on media in said media path, wherein said at least one light source is adapted to direct a first beam of light at a first wavelength, said first wavelength being within an absorption band to detect added dye in said indicia, said at least one light source being further adapted to direct a second beam of light at a second wavelength which is outside of said absorption band;
a detecting system adapted to detect a first reflected light from said first beam and provide a first signal indicative thereof, and a second reflected light from said second beam and provide a second signal indicative thereof; and
a controller adapted to receive said first and second signals and calculate a difference between said first and second signals, such that said difference represents dye on said indicia.

10. An imaging apparatus according to claim 9, wherein said indicia is a backside logo on the media.

11. An imaging apparatus according to claim 9, wherein said media is a web or a cut sheet and a photographic paper.

12. A method according to claim 9, wherein said at least one light source is a light emitting diode.
